(19) United States
(12) Patent Application Publication
(10) Pub. No.: US 2009/0252911 A1
(43) Pub. Date: Oct. 8, 2009

(54) Double-sided adhesive sheet

(76) Inventor: John C. Cheng, Altadena, CA (US)

Correspondence Address: ALBERT O COTA, 5460 WHITE OAK AVE, SUITE A-331, ENCINO, CA, 91316, US

(21) Appl. No.: 12/080,770

(22) Filed: Apr. 7, 2008

(51) Int. Cl. B32B 33/00; B32B 3/26

(52) U.S. Cl. 428/40.1; 428/304.4

(57) ABSTRACT

A double-sided adhesive sheet (10) that is comprised of a substrate (12) having a front surface (14), a rear surface (16), an upper edge (18), a lower edge (20), a right edge (22) and a left edge (24). Applied to the front surface (14) is an adhesive (30) and a front peel-off liner (38), and applied to the rear surface (16) is also an adhesive (30) and a rear peel-off liner (42). The adhesive (30) is preferably low-tack adhesive (32) although high-tack adhesive (34) can also be utilized. Extending through the front and rear surfaces (14,16) are a multiplicity of openings (46). When the rear peel-off liner (42) is removed, the adhesive sheet (10) can be removably attached to a vertical or horizontal surface (56). When the front peel-off liner (38) is removed, the multiplicity of openings (46) prevent air pockets from forming between an item (54) and the front surface (14), and between the rear surface (16) and the vertical or horizontal surfaces (56) to which the sheet (10) is attached.

### TECHNICAL FIELD

The invention generally pertains to adhesive sheets, and more particularly to a double-sided adhesive sheet that has a multiplicity of openings extending through the sheet.

### BACKGROUND ART

Many people rely on the ability to display certain items, such as paper notes, reminders, photographs, etc. Some people set up dedicated surfaces such as cork boards or metal sheets with magnets to maintain the items. The practice of taping an item to a surface is also widely used.

Unfortunately, it is not always possible and/or practical to set up a metal board, and when using a cork board, push pins typically must be inserted through the item to hold it in place. The use of tape can also damage an item since the item itself must have tape applied. For some, non-important items this is not a problem. But there are cases when a person wishes to display an item without damaging the item in any way.

As a result of this problem, double-sided adhesive sheets have been developed. The sheets typically utilize a low-tack adhesive which allows a person to removably attach a sheet onto a surface and then removably attach an item onto the sheet.

The double-sided adhesive sheets generally work well as an alternative to push pins, tape or other potentially damaging methods. The only drawbacks are that when a person places an item such as a paper note on an adhesive sheet, air pockets can form between the item and the sheet and/or between the sheet and the surface to which it is attached. This is especially prevalent when the sheet is attached to a hard surface such as a window, a stainless steel refrigerator, or a wall. Depending on the number of and size of the air pockets, it can often be difficult to read or see what is on the note, which completely defeats the purpose.

Obviously, if there were some type of adhesive sheet that could provide the non-damaging attachment means, as well as avoid air pockets, the benefits would be substantial.

| PATENT NO. | INVENTOR | ISSUED |
|---|---|---|
| 3,635,781 | Guichet | 18 Jan. 1972 |
| 3,963,851 | Toyoda | 15 Jun. 1976 |
| 5,906,883 | Blanc-Brude | 25 May 1999 |

The U.S. Pat. No. 3,635,781 discloses a pressure-sensitive recording paper that comprises in successive layers, a backing paper carrier, a releasable adhesive, a pressure-sensitive coating and a clear protective overlay on a second carrier with a releasable adhesive.

The U.S. Pat. No. 3,963,851 discloses a paper-like layer of a synthetic-resin film having a relatively high concentration of microvoids for high opacity. The film is laminated with a substrate layer of a synthetic-resin film that is coated with a tacky adhesive to produce a laminated adhesive paper, which is temporarily adhered to a backing paper and can be peeled in an intact state without tearing away from the backing paper.

The U.S. Pat. No. 5,906,883 discloses a sheet adhesive by that includes a substrate covered with an adhesive on a front surface, and non-adherent elements protruding with respect to the front surface. The substrate includes a meshing of channels opening at one edge of the sheet, and the non-adherent elements are bands forming roofs above the channels.

For background purposes and as indicative of the art to which the invention is related reference may be made to the remaining patents located in the search:

| PATENT NO. | INVENTOR | ISSUED |
|---|---|---|
| 4,395,297 | Patterson | 26 Jul. 1983 |
| 4,619,858 | Dam et al | 28 Oct. 1986 |
| 6,258,194 | Danon | 10 Jul. 2001 |
| 6,989,191 | Weissgerber | 24 Jan. 2006 |

### DISCLOSURE OF THE INVENTION

A double-sided adhesive sheet is disclosed, which is comprised of a substrate having a front surface, a rear surface, an upper edge, a lower edge, a right edge and a left edge. Applied to the front surface is preferably low-tack adhesive and a front peel-off liner. Applied to the rear surface is also preferably a low-tack adhesive and a rear peel-off liner.

Extending through the front and rear surfaces of the substrate are a multiplicity of openings. The openings are preferably circular, although linear and geometric shaped openings can also be utilized.

When the rear peel-off liner is removed, the double-sided adhesive sheet can be attached to a vertical or horizontal surface, such as a wall or a table. When the front peel-off liner is removed, an item, such as a paper note, a logo or a photograph, can be attached to the front surface of the substrate. The multiplicity of openings prevent air pockets from forming between the item and the front surface, and/or the rear surface and the vertical or horizontal surface to which the sheet is attached.

In view of the above disclosure, the primary object of the invention is to provide a double-sided adhesive sheet that can be removably attached to a vertical or horizontal surface and that allows various items to be smoothly attached onto the adhesive sheet's front surface.

In addition to the primary object of the invention, it is also an object of the invention to provide a double-sided adhesive sheet that:

can be made in various sizes,

can be made in various colors,

can be attached to a wide variety of vertical or horizontal surfaces,

can utilize high-tack adhesive for permanent attachment,

can include indicia,

can be made of bio-degradable materials,

is simple to use,

is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a front elevational view of a double-sided adhesive sheet's substrate.

FIG. 2 is a cross-sectional view of a double-sided adhesive sheet showing the substrate to which is attached by means of an adhesive a front and rear peel-off liners.

FIG. 3 is a front elevational view of the substrate having a multiplicity of linear openings.

FIG. 4 is a front elevational view of the substrate having a multiplicity of geometric openings.

FIG. 5 is a front elevational view showing the double-sided adhesive sheet attached to a vertical or horizontal surface and with an item attached to the front surface of the substrate.

### BEST MODE FOR CARRYING OUT THE INVENTION

The best mode for carrying out the invention is presented in terms of a preferred embodiment for a double-sided adhesive sheet (hereinafter “DSAS 10”).

The DSAS 10 is designed to be removably attached to a vertical or horizontal surface, such as a wall, a cork board, a refrigerator or a table. Once the DSAS 10 is attached to a vertical or horizontal surface 56, an item 54 such as a paper note, a photograph, or other comparatively lightweight item can be quickly and easily removably attached to the front of the DSAS 10. This precludes the necessity for magnets, push-pins or tape which previously have been utilized to attach an item onto a vertical or horizontal surface. Also due to the unique design of the DSAS 10 no air pockets will be formed between an item and the DSAS 10, and/or the DSAS 10 and a vertical or horizontal surface to which it is attached.

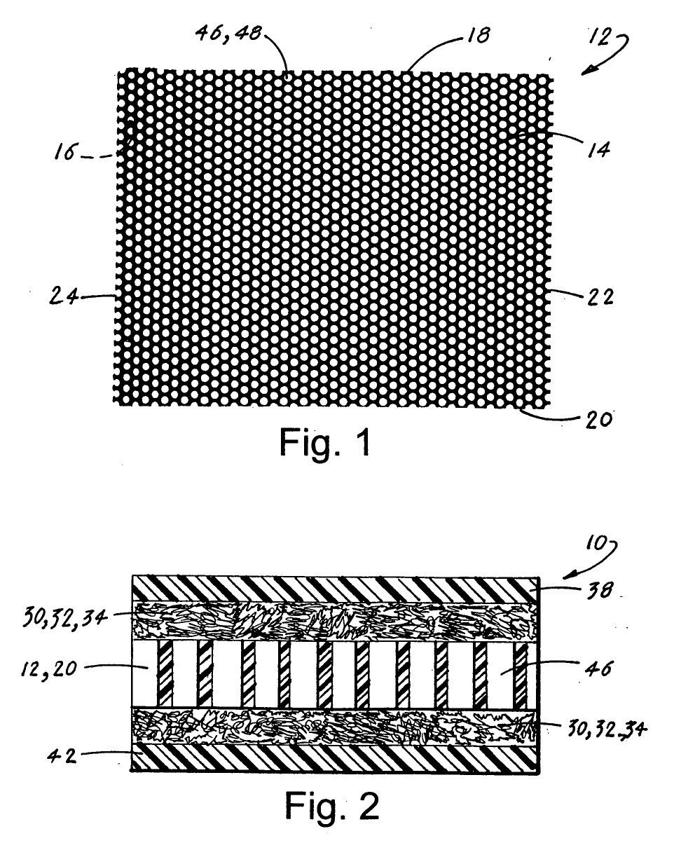

As shown in FIGS. 1-5, the DSAS 10 is comprised of five elements: a substrate 12, an adhesive 30, a front peel-off liner 38, a rear peel-off liner 42 and a multiplicity of openings 46.

The substrate 12, as shown in FIGS. 1-5, is comprised of a front surface 14, a rear surface 16, an upper edge 18, a lower edge 20, a right edge 22 and a left edge 24. The substrate 12 is preferably made of a plastic such as polyethylene, although other materials such as polyurethane, nylon or vinyl can also be utilized.

The adhesive 30, which is preferably comprised of an acrylic low-tack adhesive 32, is applied to the front and rear surfaces 14,16 of the substrate 12. The low-tack adhesive 32 allows the substrate 12 or an item attached to the substrate to be removably attached. If a permanent attachment is desired, an acrylic high-tack adhesive 34 can be utilized. Additionally, combinations of low-tack adhesive and high-tack adhesive can be utilized. For example, the rear surface 16 of the substrate 12 can have high-tack adhesive 34, with the front surface 14 having low-tack 32.

As shown in FIG. 2, the front peel-off liner 38 is applied onto the front surface 14 of the substrate 12. The rear peel-off liner 42 is applied to the rear surface 16 of the substrate 12. Both the front peel-off liner 38 and the rear peel-off liner 42 are made of a plastic or wax-lined paper.

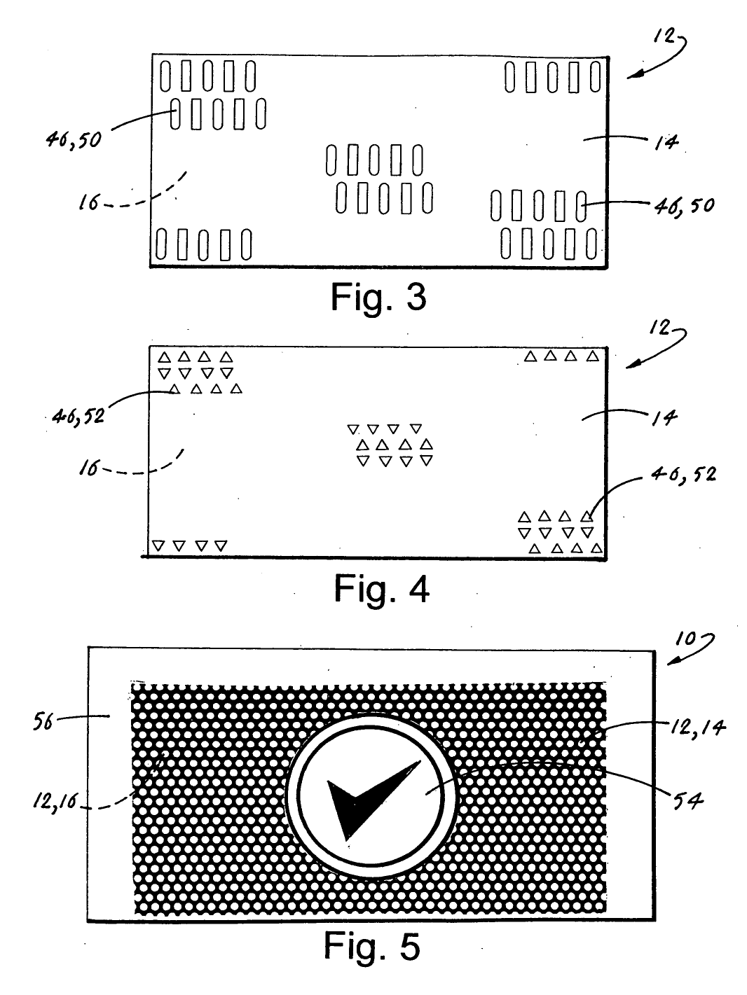

As shown in FIG. 2, the multiplicity of openings 46 extend through the front and rear surfaces 14,16 of the substrate 12. The openings 46 are preferably comprised of circular openings 46, as shown in FIG. 1. Additionally, the openings 46 can be comprised of intersecting parallel and perpendicular linear openings 50, as shown in FIG. 3; or geometric openings 52, such as square or triangular, as shown in FIG. 4. The multiplicity of openings 46 are either equi-distant, as shown in FIG. 1, or non-equi-distant, as shown in FIG. 4, and as previously disclosed the multiplicity of openings 46 prevent any air pockets from forming between an item and the front surface 14 of the substrate, and/or the rear surface 16 and a vertical or horizontal surface to which it is attached.

In order to use the DSAS 10, the rear peel-off liner 42 is removed, thereby exposing the rear surface 16 of the substrate 12 with the adhesive 30 thereon. The DSAS 10 can then be attached onto a vertical or horizontal surface 56, as shown in FIG. 5.

Once the DSAS 10 is attached to a surface 56, the front peel-off liner 38 is removed, which exposes the front surface 14 of the substrate 12 with the adhesive 30 thereon. An item 54 can then be attached onto the front surface 14, as also shown in FIG. 5.

As previously mentioned, when the low-tack adhesive 32 is utilized, the DSAS 10 itself can be removed and re-attached to another vertical or horizontal surface 56, and an item 54 attached to the front surface 14 can be removed and replaced by a different item.

Additionally, when the DSAS 10 is attached onto a pin-board, such as a cork board, a person can simultaneously use the adhesive front surface 14 as well as conventional push-pins to attach a single item 54 or multiple items, such as sheets of paper, directly onto the pin-board.

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A double-sided adhesive sheet that is comprised of a substrate having a front surface, a rear surface, an upper edge, a lower edge, a right edge and a left edge, wherein an adhesive is applied to the front surface and rear surface, wherein extending through the front and rear surfaces are a multiplicity of openings that prevent air pockets from forming beneath an item that is placed upon the front surface, and between the rear surface and a surface to which said sheet is attached.

2. The double-sided adhesive sheet as specified in claim 1 wherein said substrate is made of plastic.

3. The double-sided adhesive sheet as specified in claim 1 wherein said adhesive is comprised of an acrylic low-tack adhesive.

4. A double-sided adhesive sheet that is comprised of a substrate having a front surface, a rear surface, an upper edge, a lower edge, a right edge and a left edge, wherein applied to the front surface is an adhesive and a front peel-off liner, and applied to the rear surface is an adhesive and a rear peel-off liner, wherein extending through the front and rear surfaces are a multiplicity of openings, wherein when the rear peel-off liner is removed, said double-sided adhesive sheet can be removably attached to a vertical or horizontal surface, wherein when the front peel-off liner is removed, an item can be removably attached to the front surface, with the multiplicity of openings preventing air pockets from forming between the item and the front surface, and between the rear surface and the vertical or horizontal surface to which said sheet is attached.

5. The double-sided adhesive sheet as specified in claim 4 wherein said substrate is made of plastic.

6. The double-sided adhesive sheet as specified in claim 4 wherein said front and rear pull-off liners are made of plastic.

7. The double-sided adhesive sheet as specified in claim 4 wherein said front and rear pull-off liners are made of wax-lined paper.

8. The double-sided adhesive sheet as specified in claim 4 wherein said adhesive is comprised of an acrylic low-tack adhesive.

9. A double-sided adhesive sheet that is comprised of
a) a substrate having a front surface, a rear surface, an upper edge, a lower edge, a right edge and a left edge,
b) an adhesive that is applied to the front surface and the rear surface,
c) a front peel-off liner that is applied onto the front surface,
d) a rear peel-off liner that is applied onto the rear surface, and
e) a multiplicity of openings that extend through the front and rear surfaces, wherein when the rear peel-off liner is removed, said double-sided adhesive sheet can be removably attached to a vertical or horizontal surface, wherein when the front peel-off liner is removed, an item can be removably attached to the front surface, with the multiplicity of openings preventing air pockets from forming between the item and the front surface, and between the rear surface and the vertical or horizontal surface to which said sheet is attached.

10. The double-sided adhesive sheet as specified in claim 9 wherein said substrate is made of plastic.

11. The double-sided adhesive sheet as specified in claim 10 wherein the plastic is selected from the group consisting of polyethylene, polyurethane, nylon and vinyl.

12. The double-sided adhesive sheet as specified in claim 9 wherein said front and rear peel-off liners are made of plastic.

13. The double-sided adhesive sheet as specified in claim 9 wherein said front and rear peel-off liners are made of wax-lined paper.

14. The double-sided adhesive sheet as specified in claim 9 wherein said adhesive is comprised of an acrylic low-tack adhesive.

15. The double-sided adhesive sheet as specified in claim 9 wherein said adhesive is comprised of an acrylic high-tack adhesive.

16. The double-sided adhesive sheet as specified in claim 9 wherein said multiplicity of openings are comprised of circular openings.

17. The double-sided adhesive sheet as specified in claim 9 wherein said multiplicity of openings are comprised of intersecting parallel and perpendicular linear openings.

18. The double-sided adhesive sheet as specified in claim 9 wherein said multiplicity of openings are comprised of geometric openings.

19. The double-sided adhesive sheet as specified in claim 9 wherein said multiplicity of openings are equi-distant.

20. The double-sided adhesive sheet as specified in claim 9 wherein said multiplicity of openings are non-equi-distant.
